(19) United States
(12) Patent Application Publication
(10) Pub. No.: US 2017/0127197 A1
(43) Pub. Date: May 4, 2017

(54) HEARING ASSISTANCE SYSTEM AND METHOD

(71) Applicant: SONOVA AG, Stafa (CH)

(72) Inventors: Hans MÜLDER, Wunnewil (CH); Marc SECALL, Constantine (CH); Christoph SCHMID, Zimmerwald (CH); Markus BÜHL, Cudrefin (CH)

(73) Assignee: SONOVA AG, Stafa (CH)

(21) Appl. No.: 15/308,941

(22) PCT Filed: Jun. 4, 2014
(86) PCT No.: PCT/EP2014/061581

§ 371 Date: Nov. 4, 2016

(51) Int. Cl. H04R 25/00; G06F 3/16; G06F 3/01

(52) U.S. Cl. CPC H04R 25/558; G06F 3/017; G06F 3/165; H04R 25/554; H04R 2225/55

(57) ABSTRACT

A hearing assistance system having a hand-held audio signal wireless transmission unit for transmitting an audio signal to at least one receiver unit, and a hearing stimulating device. The transmission unit has at least one microphone for generating an audio signal, a motion sensor unit for sensing the acceleration acting on the transmission unit in three orthogonal axes and sensing the orientation of the transmission unit in space, a memory unit for storing a plurality of motion patterns of the transmission unit corresponding to gestures of a person holding the transmission unit in a hand, a control unit for identifying a motion pattern of the transmission unit from the stored motion patterns by analyzing the time dependence of an output signal of the motion sensor unit and comparing it to the stored motion patterns, and the control unit controlling operation of the transmission unit according to the identified motion pattern.

### BACKGROUND OF THE INVENTION

Field of the Invention

The invention relates to a hearing assistance system and method, wherein audio signals are transmitted from a transmission unit via a wireless link to a receiver unit, such as an audio receiver mechanically connected to or integrated in a hearing aid, from where the audio signals are supplied to means for stimulating the hearing of the user, such as a hearing aid loudspeaker.

Description of Related Art

A typical application of wireless audio systems is the case in which the transmission unit is designed as an assistive listening device. In this case, the transmission unit includes a wireless microphone for capturing ambient sound, in particular from a speaker close to the user, and/or a gateway to an external audio device, such as a mobile phone; in the latter case the transmission unit usually only acts to supply wireless audio signals to the receiver unit worn by the user.

In another typical application of wireless hearing assistance systems, wireless microphones are used by teachers teaching hearing impaired persons in a classroom (wherein the audio signals captured by the wireless microphone of the teacher are transmitted to a plurality of receiver units worn by the hearing impaired persons listening to the teacher) or in cases where one or several persons are speaking to a hearing impaired person (for example, in a professional meeting, wherein one or each speaker is provided with a wireless microphone and with the receiver units of the hearing impaired person receiving audio signals from all wireless microphones). Another example is audio tour guiding, wherein the guide uses a wireless microphone.

The wireless audio link is an FM (frequency modulation) radio link operating in the 200 MHz frequency band. Examples for analog wireless FM systems, particularly suited for school applications, are described in European Patent Application EP 1 864 320 A1 and corresponding U.S. Pat. No. 8,345,900. In recent systems, the analog FM transmission technology is replaced by employing digital modulation techniques for audio signal transmission, most of them working on other frequency bands than the former 200 MHz band.

U.S. Pat. No. 8,019,386 B2 relates to a hearing assistance system comprise a plurality of wireless microphones worn by different speakers and a receiver unit worn at a loop around a listener's neck, with the sound being generated by a headphone connected to the receiver unit, wherein the audio signals are transmitted from the microphones to the receiver unit by using a spread spectrum digital signals. The receiver unit controls the transmission of data, and it also controls the pre-amplification gain level applied in each transmission unit by sending respective control signals via the wireless link.

Wireless audio signal transmission units, such as FM transmission units, may include quite a number of functions while providing only for a limited user interface, thereby resulting in a relatively high complexity in the user interface and in the usage by the end user. While handling of such devices usually is assisted by automatic control functions, such as automatic context-dependent signal processing, such automatic choices will not be correct in all use cases for all users, and some settings may enjoy a user preference but cannot be determined by such automated context analysis.

International Patent Application Publication WO 2009/049646 A1 and corresponding U.S. Pat. No. 8,391,522 relate to hearing system comprising a wireless microphone forming part of a transmission unit which is provided with an acceleration sensor and an orientation sensor for sensing the acceleration and the orientation in order to automatically select the operation mode of the transmission unit according to the movement and/or orientation of the transmission unit; a specific operation mode is selected depending on whether the transmission unit is stationary, such as when placed on a table, or is moving, such as when hanging around the user's neck.

International Patent Application Publication WO 2011/157856 A2 and corresponding U.S. Patent Application Publication 2014/241,559 relate to a hearing assistance system comprising a wireless mobile microphone assembly provided with an acceleration sensor for sensing the acceleration acting on the microphone assembly, wherein the acceleration signal is analyzed in order to decide whether there is a drop-down event of the microphone assembly, in which case the audio signal output is interrupted.

International Patent Application Publication WO 2007/018631 A1and corresponding U.S. Pat. No. 8,761,840 relate to a gesture controlled mobile communication device which may be a mobile phone, a PDA or a notebook, and which includes motion sensors for recognizing motion patterns of the device which may be predefined or which may be learned during use of the device.

U.S. Pat. No. 8,949,744 B2 relates to a system comprising a headset which is provided with acceleration sensors, travel distance sensors, gyrators and movement sensors for detecting movement positions at the user's head for controlling an external device wirelessly connected to the headset, such as a telephone, a computer or a media player; the system can be trained for recognizing certain movement patterns in a training mode.

U.S. Patent Application Publication 2012/0020502 A1 relates to a system comprising a headphone and an audio source supplying a stereo signal to the headphone, wherein the audio signal is processed according to head rotation detected by the headphone in order to optimize spatial sound effects perceived by the user of the headphones; the headphone may be provided with gyroscopes, and signal processing may be controlled by head gesture detection, such as shaking of the head.

International Patent Application Publication WO 2010/138520 A1 and corresponding U.S. Patent Application Publication 2010/306711 relate to a Bluetooth headset which is provided with motion sensors and GPS sensors and which communicates via a Bluetooth link with a mobile phone, wherein the headset is able to detect a motion context in order to control functions like the output sound level.

U.S. Pat. No. 8,405,528 B2 relates to a gesture sensitive headset for controlling a media player device, wherein the cord from the headphone to the media player may be pressure or capacitance sensitive.

U.S. Patent Application Publication 2008/0130910 A1 relates to a headset provided with a region which is sensitive to gestures performed by the fingers of the user for enabling control of the headset.

U.S. Patent Application Publication 2011/0044483 A1 relates to a hearing aid fitting system controlled by gestures and movements of the patient or the audiologist.

U.S. Pat. No. 9,226,069 B2 relates to a communication device, such as a PDA, mobile phone or computing device, which comprises a plurality of microphones, wherein microphone operation is controlled by moving a stylus relative to the microphones and/or by recognition of gestures of the moving fingers of the user.

### SUMMARY OF THE INVENTION

It is an object of the invention to provide for a wireless hearing assistance system and method wherein the audio signal transmission unit comprising the microphone allows for easy and convenient user control, in particular also for designs wherein the size of the transmission unit is relatively small and thus the control elements are limited.

According to the invention, this object is achieved by a hearing assistance system and method as described herein.

The invention is beneficial in that, by providing the transmission unit with a motion sensor unit for sensing the acceleration and the orientation of the transmission unit, a memory unit for storing a plurality of motion patterns of the transmission unit corresponding to gestures of a user holding the transmission unit in a hand, and a control unit for identifying a motion pattern of the transmission unit from the stored motion patterns by analyzing the output signal of the motion sensor unit and comparing it to the stored motion patterns, with the transmission unit—and thus via the transmission unit the entire system—being controlled according to the identified motion pattern, the user is enabled to control operation of the transmission unit, i.e., the wireless microphone, by gestures, whereby easy and reliable handling of the transmission unit is enabled also for users with limited manual dexterity and/or vision; further, access to manual control functions of the transmission unit may be accelerated, since a gesture can be performed faster than manual operation of a small button or switch. Also, by implementing such gesture control, certain design restrictions resulting from a need to provide the transmission unit with mechanical elements for manual control, such as buttons or switches, can be eliminated; thereby further miniaturization of the transmission unit is enabled.

Hereinafter, the invention will be described by reference to the accompanying drawing.

### BRIEF DESCRIPTION OF THE DRAWINGS

FIG. 1 is a schematic view of a use of an example of a hearing assistance system according to the invention;

FIG. 2 is a block diagram of an example of a transmission unit to be used with the invention; and

FIG. 3 is a block diagram of an example of a receiver unit to be used with the invention.

### DETAILED DESCRIPTION OF THE INVENTION

In FIG. 1 a typical use case of a hearing assistance system according to the invention is shown schematically, the system comprising a hand-held audio signal transmission unit 10 including a microphone arrangement 17 (shown in FIG. 2) and an audio signal receiver unit 14 connected to or integrated within a hearing aid 16. The receiver unit 14 and the hearing aid 16 are worn by a hearing impaired person 13; typically, the hearing impaired person 13 will wear a receiver unit 14 and a hearing aid 16 at each of the ears. In the example of FIG. 1, the transmission unit 10 is used for capturing the voice of a person 11 speaking to the hearing impaired person 13, with the audio signals captured by the microphone arrangement 17 of the transmission unit 10 being transmitted via a digital audio link 12 to the receiver unit 14. Preferably, the wireless audio link 12 is part of a digital data link using, for example, the 2.4 GHz ISM band. An example of such an audio link is described in International Patent Application Publication WO 2011/098140 A1 and corresponding U.S. Pat. No. 9,137,613.

The transmission unit 10 may be held by the person 11 or by the person 13, depending on the specific use situation. The transmitted audio signals will be reproduced to the person 13 via the hearing aids 16. The transmission unit 10 thus acts as a wireless personal microphone of the hearing-impaired person 13.

Typically, the transmission unit 10 also comprises a wired and/or wireless audio input for connection to external audio devices, such as a mobile phone, a FM radio, a music player, a telephone or a TV device.

An example of such transmission unit 10 is shown in FIG. 2, the transmission unit 10 comprising the microphone arrangement 17 for capturing audio signals from the voice of the respective speaker 11, an audio signal processing unit 20 for processing the captured audio signals, a digital transmitter 28 and an antenna 30 for transmitting the processed audio signals as an audio stream consisting of audio data packets. The audio signal processing unit 20 serves to compress the audio data using an appropriate audio codec. The compressed audio stream forms part of a digital audio link 12 established between the transmission units 10 and the receiver unit 14, which link also serves to exchange control data packets between the transmission unit 10 and the receiver unit 14.

The transmission units 10 also may include a classifier unit 24 for analyzing the audio signals captured by the microphone arrangement 17 in order to determine the presently prevailing auditory scene category. The classifier unit 24 generates a corresponding output signal which serves to control the operation of the transmission unit 10 and/or the receiver unit 14 according to the determined auditory scene category. In the example shown in FIG. 2 the classifier unit 24 is implemented as a voice activity detector (VAD) (in this case, the auditory scene categories would be “voice on” and “voice off”).

The audio signal processing unit 20 and other components, such as the classifier unit/VAD 24, may be implemented by a digital signal processor (DSP) 22. In addition, the transmission units 10 also may comprise a microcontroller 26 acting on the DSP 22 and the transmitter 28. The microcontroller 26 may be omitted in case that the DSP 22 is able to take over the function of the microcontroller 26.

Preferably, the microphone arrangement 17 comprises at least two spaced-apart microphones 17A, 17B, the audio signals of which may be used in the audio signal processing unit 20 for acoustic beamforming by a beamformer 21 in order to provide the microphone arrangement 17 with a directional characteristic. The output audio signal of the beamformer 21 is supplied to a gain model unit 23 which applies, for example, an automatic gain control (AGC) function to the audio signals.

Typically, a plurality of audio signal processing modes is implemented in the transmission unit 10 and/or in the receiver unit 14.

The VAD 24 uses the audio signals from the microphone arrangement 17 as an input in order to determine the times when the person 11 using the respective transmission unit 10 is speaking. The VAD 24 may provide a corresponding control output signal to the microcontroller 26 in order to have, for example, the transmitter 28 sleep during times when no voice is detected and to wake up the transmitter 28 during times when voice activity is detected. In addition, a control command corresponding to the output signal of the VAD 24 may be generated and transmitted via the wireless link 12 in order to mute the receiver units 14 or saving power when the user 11 of the transmission unit 10 does not speak. To this end, a unit 32 is provided which serves to generate a digital signal comprising the audio signals from the processing unit 20 and the control data generated by the VAD 24, which digital signal is supplied to the transmitter 28.

The transmission unit 10 also may comprise inputs for audio signals supplied by external audio sources 34 and 36, such as a plug-in interface 38 and/or a wireless interface 40, such as a BLUETOOTH® interface. Such external audio sources 34, 36 may be, for example, a phone, a mobile phone, a music player, a computer or a TV set. In particular, by providing such interfaces 38, 40 a plurality of audio signal input channels to the transmission unit 10 are realized. The wireless interface 40 is particularly useful for connecting a mobile phone 36 to the transmission unit 10 via a BLUETOOTH® link 39.

The transmission unit 10 also includes a memory 46 for storing default values of the setting of operation parameters of the transmission unit 10. Such default values may include the selection of the audio signal input channels, the setting of at least one parameter of the audio signal processing in the transmission unit 10 and/or in the receiver unit 14, in particular the default audio signal processing mode of the transmission unit 10 and/or the receiver unit 14 and/or a default volume setting in the receiver unit 14.

The transmission unit 10 also comprises a motion sensor 44 for sensing the acceleration acting on the transmission unit 10 with regard to three orthogonal axes and for sensing the orientation of the transmission unit 10 in space, with the sensor unit 44 generating a corresponding output signal indicative of the acceleration and the orientation of the transmission unit.

The motion sensor unit 44 may comprise a three-axes gyrometer sensor or linear accelerometer; these sensors are able to detect angular momentum or linear accelerations very precisely, and motion paths (trajectories) can be determined by integrating the momentum or acceleration values over time; further, since a linear accelerometer sensor also senses the gravity acceleration, it is able to detect the orientation in space. Alternatively, the sensor unit 44 may comprise a three-axis magnetic sensor (compass).

The output signal of the sensor unit 44 is supplied to a control unit 42 which is provided for identifying a motion pattern of the transmission unit 10 by analyzing the time dependence of the output signal of the motion sensor unit 44 and comparing it to motion patterns stored in the data memory 46 of the transmission unit 10. The present motion pattern is identified as the stored motion pattern which has the least deviation concerning the present output signal sequence of the motion sensor unit 44 (the “least deviation” may be defined in a suitable manner, such as “least square”, etc.). The stored motion patterns correspond to various gestures of the user when holding the transmission unit 10 in his hand (however, also the default “no gesture” state of transmitter 10 shall be identified and has to be potentially discarded).

Thus, the control unit 42 serves to recognize the presently applied gesture of the user of the transmission unit 10 and to implement a corresponding gesture control concerning certain functions during operation of the transmission unit 10. To this end, the control unit 42 is adapted to control operation of the transmission unit 10 according to the presently identified motion pattern.

In principle, the motion patterns stored in the memory 46 may be predefined. However, preferably the stored motion patterns are user specific. This can be achieved, for example, by implementing a “training mode” in which the control unit 44 records individual motion patterns of the user holding the transmission unit 10 in his hand by recording the respective output of the motion sensor unit 44 and storing the respective integral motion pattern in the memory 46.

Preferably, at a certain time the control unit 42 may only access a subset of the predefined gestures contained in the memory 46, depending on the current state of the transmission unit 10, e.g., in case of an incoming phone call, only the functions related to the phone activation would be enabled.

The various motion patterns may be distinguished by the direction of a linear movement with regard to a reference axis of the transmission unit 10, the direction of a linear movement with regard to the direction of gravity (or with regard to the magnetic north pole in case the sensor unit 44 comprises a magnetic sensor), the speed of a linear movement, the acceleration magnitude of linear movement and a sequence of turns of the transmission unit 10 (by using, for example a gyroscope included in the sensor unit 44).

According to one embodiment, the control unit 42 is adapted to select a certain audio signal processing mode of the audio signal processing unit 20. For example, the control unit 42 may be adapted to control the beam former 21 according to the identified motion pattern. Typically, the beam former 21 may have three different operation modes: an omni-directional mode (i.e., wherein there is no beam forming at all), a “zoom” mode with moderate beam forming and a “super zoom” mode with pronounced beam forming (i.e., with a relatively narrow angular width of the beam). By performing different gestures, the user then may select the desired beam former mode: For example, the omni-directional mode may be entered by a relatively gentle rotation of the transmission unit around its longitudinal axes (such as in a cone shaped movement, with the tip of the device describing a circular movement e.g., in case of an oblong shaped device) and the “zoom” or “super zoom” mode may be entered by a rapid pointing movement of the transmission unit 10 with different speed.

The control unit 42 also may be used to change between a “sleep mode” and a “normal” operation mode (“active mode”) of the transmission unit 10. For example, the sleep mode may be entered by a relatively gentle downward movement of the transmission unit 10, and the active mode may be entered by relatively fast upward movement of the transmission unit 10.

Gesture recognition also may be used for controlling communication with a mobile phone 36 via the BLUETOOTH link 39 and the BLUETOOTH® interface 40. In particular, the control unit 42 may cause the transmission unit 10 to accept or reject an incoming telephone call according to the presently identified motion pattern (i.e., the “accept/reject” function of the mobile phone 36 is controlled accordingly via the BLUETOOTH® link 39). For example, a phone call may be accepted by a rapid upward movement of the transmission 10 and it may be rejected by a left-right-left movement of the transmission unit 10.

Gestures/motion patterns to be used for control of the transmission unit 10 may be differentiated from the normally occurring movements of the transmission, unit 10 during regular use by travel distance, speed, acceleration and sequence of turns (in particular repetition of certain movements).

Preferably, the transmission unit 10 is designed such that control by the control unit 42 based on the identified motion pattern is prioritized over automatic control based on other criteria, e.g., the control exerted by the classifier 24, so that an override function of manual gesture control over automatic control is implemented.

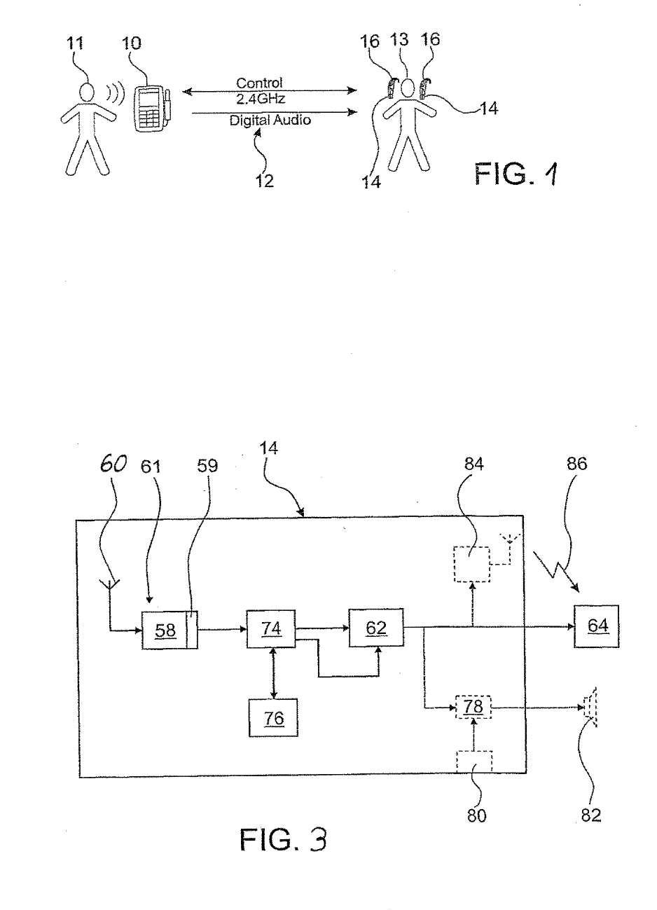

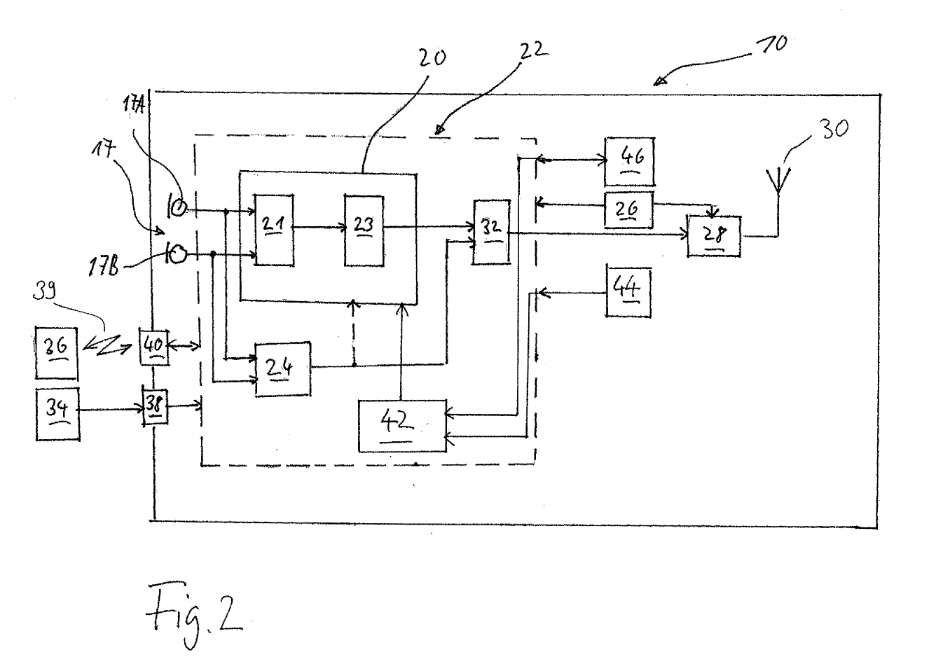

An example of a digital receiver unit 14 is shown in FIG. 3, according to which an antenna arrangement 60 is connected to a digital transceiver 61 including a demodulator 58 and a buffer 59. The signals transmitted via the digital link 12 are received by the antenna 60 and are demodulated in the digital radio receivers 61. The demodulated signals are supplied via the buffer 59 to a DSP 74 acting as processing unit which separates the signals into the audio signals and the control data and which is provided for advanced processing, e.g., equalization, of the audio signals according to the information provided by the control data. The receiver unit 14 also includes a memory 76 for the DSP 74. The processed audio signals, after digital-to-analog conversion, are supplied to a variable gain amplifier 62 which serves to amplify the audio signals by applying a gain controlled by the control data received via the digital link 12. The amplified audio signals are supplied to the audio input of a hearing aid 64. The receiver unit 14 preferably is designed to allow the user of the receiver unit 14 to select between the audio output of the receiver unit and the microphone arrangement of the hearing aid 64 as the audio signal input to be processed and provided as processed audio signals to the hearing aid speaker.

Rather than supplying the audio signals amplified by the variable gain amplifier 62 to the audio input of a hearing aid 64, the receiver unit 14 may include a power amplifier 78 which may be controlled by a manual volume control 80 and which supplies power amplified audio signals to a loudspeaker 82 which may be an ear-worn element integrated within or connected to the receiver unit 14. Volume control also could be done remotely from the transmission unit 10 by transmitting corresponding control commands to the receiver unit 14. It is to be noted that such control commands may originate from detected gestures so that the gesture controlled transmission unit does not only control local functions, but may act on the whole system via gesture control.

Another alternative implementation of the receiver unit may be a neck-worn device having a transmitter 84 for transmitting the received signals via with a magnetic induction link 86 (analog or digital) to the hearing aid 64 (as indicated by dotted lines in FIG. 3).

What is claimed is:

1. A hearing assistance system comprising a hand-held audio signal transmission unit (10) for transmitting an audio signal via a wireless link (12) to at least one receiver unit (14) for reception of audio signals from the transmission unit via the wireless link, and means (16, 64, 82) for stimulating the hearing of a user according to an audio signal supplied from the receiver unit,
the transmission unit comprising:
at least one microphone (17, 17A, 17B) for generating an audio signal from sound impinging on the least one microphone,
a motion sensor unit (44) for sensing the acceleration acting on the transmission unit with regard to three orthogonal axes and sensing the orientation of the transmission unit in space,
a memory unit (46) for storing a plurality of motion patterns of the transmission unit corresponding to gestures of a person (11, 13) holding the transmission unit in a hand,
a control unit (42) for identifying a motion pattern of the transmission unit from the stored motion patterns by analyzing the time dependence of an output signal of the motion sensor unit and comparing it to the stored motion patterns, wherein the control unit is adapted to control operation of the transmission unit according to the identified motion pattern.

2. The system of claim 1, wherein the motion sensor unit (44) comprises at least one of a three-axes gyrometer sensor, a three-axes linear accelerometer and a three-axes magnetic sensor.

3. The system of claim 1, wherein the control unit is adapted to indentify the motion patterns by at least one of the direction of a linear movement with regard to a reference axis of the transmission unit (10), the direction of a linear movement with regard to the direction of gravity, the direction of a linear movement with regard to the direction of the magnetic north pole of the earth, the speed of a linear movement, the acceleration magnitude of a linear movement, and the sequence of turns.

4. The system of claim 1, wherein the motion patterns are predefined.

5. The system of claim 4, wherein control unit (42) is adapted to identify only a subset of the predefined patterns, depending on the operation mode of the transmission unit (10).

6. The system of claim 1, wherein the control unit (42) is adapted to record individual motion patterns of a person (11, 13) holding the transmission unit (10) in a hand from the output of the motion sensor unit (44) and store the individual motion patterns in the memory (46) as said plurality of motion patterns.

7. The system of claim 1, wherein the control unit (42) is adapted to select an audio signal processing mode of an audio signal processing unit (20) of the transmission unit (10) provided for processing the audio signal captured by the microphone (17, 17A, 17B) prior to transmission according to the identified motion pattern.

8. The system of claim 7, wherein the control unit (42) is adapted to control a beamformer (21) of the audio signal processing unit (20) according to the identified motion pattern.

9. The system of claim 1, wherein the transmission unit (10) comprises an interface (38, 40) for receiving an external audio signal from an external audio source (34, 36), and wherein the control unit (42) is adapted to control the interface according to the identified motion pattern.

10. The system of claim 9, wherein the external audio source is a telephone device (36) and wherein the control unit (42) is adapted to accept or reject an incoming telephone call according to the identified motion pattern.

11. The system of claim 9, wherein the interface (40) is a BLUETOOTH® interface.

12. The system of claim 1, wherein the control unit (42) is adapted to switch the transmission unit (10) from an active mode into a sleep mode or from the sleep mode into the active mode according to the identified motion pattern.

13. The system of claim 1, wherein the control unit (42) is adapted to prioritize control according to the identified motion pattern over control based on other criteria in order to implement an override function of manual control over automatic control.

14. The system of claim 1, wherein the receiver unit (14) is to be worn at ear level.

15. The system of claim 14, wherein the receiver unit (14) is connected to or integrated into a hearing aid (16, 64).

16. The system of claim 1, wherein the wireless link is a digital link (12).

17. A method of providing hearing assistance to a user (13), comprising
generating, by at least one microphone (17, 17A, 17B) of a hand-held audio signal transmission unit (10), an audio signal from sound impinging on the microphone,
transmitting an audio signal via a wireless audio link (112) to a receiver unit (14),
stimulating the hearing of the user according to an audio signal supplied from the receiver unit,
sensing, by a motion sensor unit (44) of the transmission unit, the acceleration acting on the transmission unit with regard to three orthogonal axes and the orientation of the transmission unit in space,
identifying, by a control unit (42) of the transmission unit, a motion pattern of the transmission unit from a stored plurality of motion patterns of the transmfssion unit corresponding to gestures of a user holding the transmission unit in a hand by analyzing the time dependence of an output signal of the motion sensor assembly and comparing it to the stored motion patterns, and
controlling, by the control unit, operation of the transmission unit according to the identified motion pattern.

18. The method of claim 17, wherein functions of the receiver unit (14) and / or a hearing aid (16, 64) connected to the receiver unit are controlled through the identified motion pattern of the transmission unit (10).
